(19) United States
(12) Patent Application Publication
(10) Pub. No.: US 2002/0132131 A1
(43) Pub. Date: Sep. 19, 2002

(54) Protective coating for a thermally stressed component, particularly a turbine component

(76) Inventors: Hans-Peter Bossmann, Wiesloch (DE); Axel Kranzmann, Stuttgart (DE); Harald Reiss, Heidelberg (DE); Hans Joachim Schmutzler, Maikammer (DE); Marianne Sommer, Walldorf (DE); Ludwig Weiler, Darmstadt (DE)

Correspondence Address: Robert S. Swecker, BURNS, DOANE, SWECKER & MATHIS, L.L.P., P.O Box 1404, Alexandria, VA, 22313-1404, US

(21) Appl. No.: 10/006,699

(22) Filed: Dec. 10, 2001

(30) Foreign Application Priority Data
Dec. 23, 2000 (DE) 100 65 207.7

(51) Int. Cl. B32B 15/04; B32B 15/00

(52) U.S. Cl. 428/615; 428/469; 416/241 R

(57) ABSTRACT

The invention relates to a sealing coating for a thermally stressed component, particularly a turbine component, for protection from corrosion and/or oxidation and/or erosion. To improve the life of the protective coating or of the component, the protective coating has a single-layer or multilayer sealing coating of an amorphous material.

### FIELD OF THE INVENTION

The invention relates to a protective coating for a thermally stressed component, particularly a turbine component, for protection against corrosion and/or oxidation and/or erosion.

Turbine components, particularly turbine blades, are exposed to corrosive and/or oxidizing and/or erosive media. The turbine components usually consist of materials which are optimized as regards the mechanical loads which arise in operation of the turbine. These materials, which are for example based on nickel-based alloys, are however relatively susceptible to corrosion, oxidation and/or erosion. Usual basic materials for turbine components, particularly for turbine blades, are: CM 247, CMSX 4, and IN 738.

### DESCRIPTION OF PRIOR ART

In order to increase the life of turbine components, their corrosion resistance can be improved by the application of a protective coating of the kind mentioned at the beginning. Known protective coatings consist of a metallic, crystalline material, which usually contains, besides other chemical elements, a sufficient content of the constituents aluminum and chromium. Here the aluminum provides for the desired oxidation protection, since a protective aluminum oxide layer gradually grows on the outermost surface of the protective coating. The alloy element chromium supports the formation of the protective aluminum oxide layer. The life of such a protective coating is however limited, since the protective aluminum oxide layer continues to grow, so that more and more aluminum is withdrawn from the protective coating. The strength and thus also the life of the protective coating are reduced with its decreasing aluminum content. The life of the component to be protected then also decreases, due to the damage to the protective coating.

### SUMMARY OF THE INVENTION

The invention will provide a remedy here. The invention has as its object to provide an embodiment for a protective coating of the kind mentioned at the beginning, which has an increased life.

According to the invention, this object is attained in that the protective coating has a single layer or multilayer sealing coating of an amorphous material.

The invention is based on the general concept of making use of the advantageous properties of an amorphous structure in materials which are suitable for protection from corrosion and/or oxidation and/or erosion, for the manufacture of a long-life protective coating. Amorphous materials or amorphous structures are distinguished by a low thermal conductivity, low diffusion speeds, and also high hardness and high thermal stability. The implementation according to the invention of these properties in a corrosion resistant and/or oxidation resistant and/or erosion resistant material leads to a protective coating with increased life.

The invention makes use of the knowledge that the weak places of a conventional protective coating, or the weak places of the component surface, are situated in the grain boundaries at which adjacent crystals of a crystalline structure border on each other. For example, an increased concentration of alloy impurities, which as a rule are susceptible to corrosion, oxidation, or erosion, prevails at the grain boundaries. Crystalline materials, with the exception of monocrystalline structures, always have many of these grain boundaries on their exterior, exposed to the aggressive media. In contrast to this, an amorphous structure possesses no grain boundaries, so that local concentrations of impurities and thus weak places in the amorphous sealing layer are avoided. The amorphous structure of the sealing coating thus presents fewer points of attack to the aggressive media and thus has an increased life.

Furthermore, such a sealing coating can be produced with high quality, and in particular has no holes or gaps. The diffusion of aggressive atoms or molecules into the sealing coating or through the sealing coating can hereby be slowed. In contrast to a naturally growing aluminum oxide layer, in which gaps or holes can occur between the forming crystals, there thereby results a further improvement of the protective effect and thus of the life of the protective coating, and lastly of the coated component.

In a first embodiment, the sealing coating can be arranged on the surface of the component. The long-lived sealing coating hinders the transport of aggressive molecules or atoms, e.g., oxygen, to the component, so that the component can be assured of a long life.

In a second embodiment, the protective coating can have, in addition to a sealing coating, a single-layer or multilayer component coating of a crystalline material, which is arranged on the surface of the component, the sealing coating then being arranged on the component coating. This component coating can for example consist of a conventional protective layer with a crystalline material, e.g., of a nickel-based alloy. As mentioned at the beginning, such a component coating can admittedly offer a relatively high-quality protection from corrosion, oxidation and erosion, but however has a relatively short life because of the free grain boundaries. The grain boundaries of this component coating are protected by the sealing coating applied thereon from a direct attack of the aggressive media, so that the life of this coating is clearly increased.

In a preferred development, the protective coating according to the invention can additionally have a single-layer or multilayer heat insulating coating, which is arranged on the sealing coating. The action of temperature on the sealing layer, and also on the component and insofar as present—also the (conventional) component coating, is reduced with the aid of such a heat insulating coating. For example, required mechanical properties of the base material of the component can thereby be ensured. Such a heat insulating coating can for example consist of stabilized zirconium oxide.

In order to be able to ensure a high mechanical stability for the amorphous sealing coating, this is made relatively thin. A thickness of less than 20 μm is preferred here. Of particular advantage is a sealing coating with a thickness of about 0.1 μm to 10 μm.

In an advantageous embodiment, the sealing coating is applied to a single-crystal or directionally solidified material.

Further important features and advantages of the protective coating according to the invention will become apparent from the dependent claims, from the accompanying drawings, and from the associated description of Figures with reference to the drawings.

### BRIEF DESCRIPTION OF THE DRAWINGS

Preferred embodiments of the invention are shown in the drawings and are explained in detail in the following description.

FIG. 1 is a schematic sectional diagram of a region of a component which is equipped with a protective coating according to the invention, in a first embodiment,

FIG. 2 is a schematic sectional diagram as in FIG. 1, but in a second embodiment,

FIG. 3 is a schematic sectional diagram as in FIG. 1, but in a third embodiment, and

FIG. 4 is a schematic sectional diagram as in FIG. 1, but in a fourth embodiment.

### DESCRIPTION OF PREFERRED EMBODIMENTS

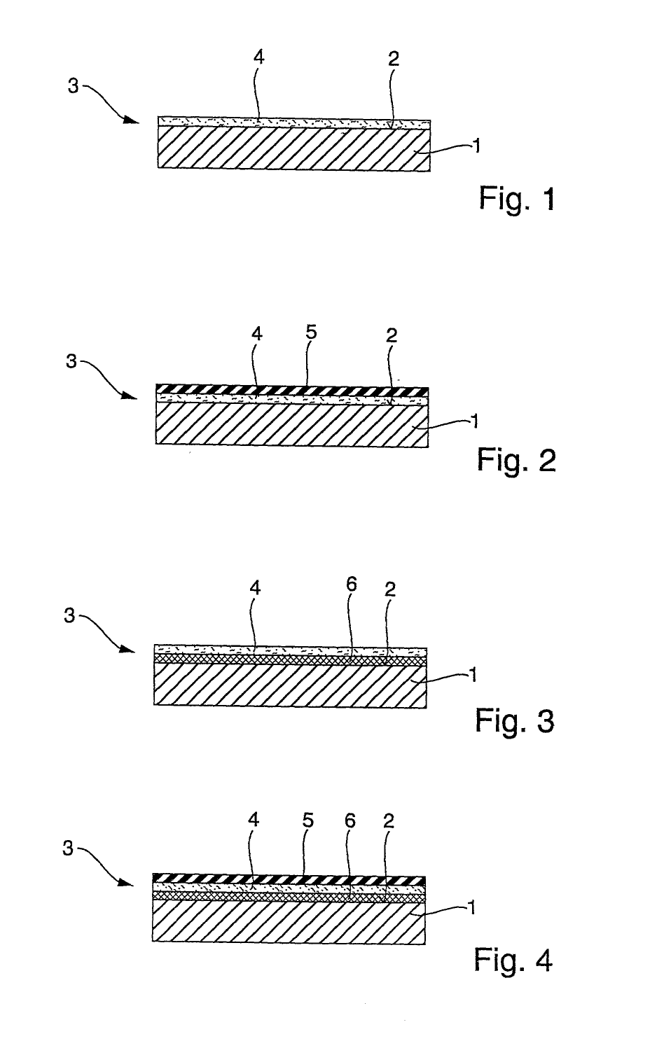

Corresponding to FIGS. 1-4, a component 1 (shown only locally), for example a turbine blade, can be coated on its outer surface 2 with a protective coating 3 according to the invention for protection against corrosion and/or oxidation and/or erosion. This protective coating 3 has a single-layer or multilayer sealing coating 4, which consists of an amorphous material or of a material with an amorphous structure. The amorphous sealing coating 4 can consist of an amorphous metal, an amorphous transition metal, an amorphous alloy, or an amorphous nonmetallic compound, or of combinations of these materials. Preferably the sealing coating 4 consists of an aluminum oxide based or silicon carbonitride based material, or of an yttrium oxide containing or cerium oxide containing material. To attain a high stability, the sealing coating 4 is preferably made relatively thin, i.e., its extent or thickness perpendicular to the surface 2 of the component 1 is relatively small. For example, the thickness of the sealing coating 4 is less than 20 μm. Of particular advantage is a thickness of the sealing coating 4 of about 0.1 μm to 10 μm.

It is clear that for the production of the amorphous sealing coating 4, a material is used which already has per se a sufficient thermal stability and also sufficient corrosion resistance and/or oxidation resistance and/or erosion resistance. The protective effect of such a material is clearly improved by the proposed amorphous structure.

According to FIG. 1, the protective coating 3 according to the invention in a first embodiment consists exclusively of the sealing coating 4, which correspondingly is arranged directly on the surface 2 of the component 1. The sealing coating 4, preferably of amorphous aluminum oxide or amorphous silicon carbonitride, can for example be applied to the component 1 by a physical vapor deposition process (PVD process) or by a chemical vapor deposition process (CVD process). A laser PVD process or a laser CVD process are preferred. The material of the component 1 is thus effectively protected from the attack of aggressive media by the protective coating 4, so that the component 1 has an increased service life.

According to FIG. 2, the protective coating 3 according to the invention in a second embodiment has a heat insulating coating 5 in addition to the sealing coating 4. While the sealing coating 4 is arranged on the surface 2 of the component 1, the heat insulating coating 5 is situated on the sealing coating 4. The heat insulating coating 5 can for example consist of a stabilized zirconium oxide, which is appropriately applied by air plasma spraying, flame spraying, or by an electron beam PVD process, as a single layer or a multilayer. The temperature of the sealing coating 4 and also of the component 1 can be reduced by the heat insulating coating 5, in order, for example, to be able to ensure given required mechanical properties, e.g., stability, rigidity, or extension behavior of the sealing coating 4 or of the component 1.

According to FIG. 3, the protective coating 3 according to the invention in a third embodiment can have, in addition to the sealing coating 4, a component coating 6 formed for example from a crystalline material in the manner of a conventional protective layer. Here the single-layer or multilayer component coating 6 is arranged directly on the surface 2 of the component 1, while the sealing coating 4 is applied to the component coating 6. In this embodiment, the sealing coating 4 protects the component coating 6 and in particular its corrosion-sensitive and/or oxidation sensitive and/or erosion sensitive grain boundaries from a direct attack by the aggressive media. The life of the crystalline component coating 6, and thus the life of the component 1, are hereby increased.

According to FIG. 4, in a fourth embodiment the protective coating 3 according to the invention can have, in addition to the sealing coating 4 and the component coating 6, furthermore a heat insulating coating 5, the crystalline component coating 6 being arranged on the surface 2 of the component 1, the amorphous sealing coating 4 on the component coating 6, and the heat insulating coating 5 on the sealing coating 4. The heat insulating coating 5 can thus reduce the thermal loading of the sealing coating 4, the component coating 6, and the component 1.

### LIST OF REFERENCE NUMERALS

1 component

2 surface of 1

3 protective coating

4 sealing coating

5 heat insulating coating

6 component coating

1. Protective coating for a thermally stressed component (1), particularly a turbine component, for protection from corrosion and/or oxidation and/or erosion, the protective coating (3) having a single-layer or multilayer sealing coating (4) of an amorphous material.

2. Protective coating according to claim 1, wherein the sealing coating (4) consists of an amorphous metal or of an amorphous transition metal or of an amorphous metallic alloy or of a non-metallic compound or of a combination of these materials.

3. Protective coating according to claim 1 or 2, wherein the sealing coating (4) is arranged on the surface (2) of the component (1).

4. Protective coating according to claim 1 or 2, wherein the protective coating (3) has a single-layer or multilayer component coating (6) of a crystalline material, which is arranged on the surface (2) of the component (1), the sealing coating (4) being arranged on the component coating (6).

5. Protective coating according to one of claims 1-4, wherein the protective coating (3) has a single-layer or multilayer heat insulating coating (5) which is arranged on the sealing coating (4).

6. Protective coating according to one of claims 1-5, wherein sealing coating (4) is relatively thin.

7. Protective coating according to one of claims 1-6, wherein the sealing coating (4) is less than 20 μm thick.

8. Protective coating according to one of claims 1-7, wherein the sealing coating (4) is about 0.1 μm to 10 μm thick.

9. Protective coating according to one of claims 1-8, wherein the sealing coating (4) consists of an oxide-based material.

10. Protective coating according to one of claims 1-9, wherein the sealing coating (4) consists of an aluminum oxide based or silicon carbonitride based material or of an yttrium oxide containing or cerium oxide containing material.

11. Protective coating according to one of claims 1-10, wherein the sealing coating (4) is directly applied to a single-crystal or directionally solidified material.
